(19) United States
(12) Patent Application Publication
(10) Pub. No.: US 2009/0188052 A1
(43) Pub. Date: Jul. 30, 2009

(54) MULTIPURPOSE TOOL

(75) Inventors: Jeff Wright, Bulverde, TX (US); Jeff Waters, Bulverde, TX (US)

Correspondence Address: GUNN & LEE, P.C., 700 N. ST. MARY'S STREET, SUITE 1500, SAN ANTONIO, TX, 78205, US

(73) Assignee: BREACHING TECHNOLOGIES, INC., San Antonio, TX (US)

(21) Appl. No.: 12/013,037

(22) Filed: Jan. 11, 2008

Related U.S. Application Data
(60) Provisional application No. 60/884,579, filed on Jan. 11, 2007.

(51) Int. Cl. B26B 11/00

(52) U.S. Cl. 7/158

(57) ABSTRACT

A multipurpose tool comprising a main body and having at least one substantially planar member extending from the main body, at least one curved member extending from the main body, and at least one serrated member extending from the main body. The tool may also have at least one base extending from the main body. The tool may also have one or more handles extending from the main body.

### CROSS REFERENCE TO RELATED APPLICATIONS

This original nonprovisional application claims the benefit of U.S. provisional application No. 60/884,579, filed Jan. 11, 2007 and entitled “Multipurpose Tool,” which is incorporated by reference herein.

### STATEMENT REGARDING FEDERALLY SPONSORED RESEARCH OR DEVELOPMENT

Not applicable.

### BACKGROUND OF THE INVENTION

1. Field of the Invention

The present invention relates generally to hand tools.

2. Description of the Related Art

A number of tools exist that are designed for use in public safety, law enforcement, or emergency response, such as but not limited to response to fires or vehicle accidents. Many of these tools provide the necessary method of rescuing persons from emergency situations or allowing law enforcement officials to gain access to a building. The alternative of not having tools in these situations could be deadly, for example, when a person is trapped in a wrecked vehicle or a burning building. With existing tools, many are specialized, very large, or expensive, which hinders the ability for many public service personnel, such as law enforcement officials or firefighters, to either transport the tool or have ready access to the tool.

### BRIEF SUMMARY OF THE INVENTION

The present invention is a multipurpose tool comprising a main body and having at least one substantially planar member extending from the main body, at least one curved member extending from the main body, and at least one serrated member extending from the main body. The tool may also have at least one base extending from the main body. The tool may also have one or more handles extending from the main body.

### BRIEF DESCRIPTION OF THE SEVERAL VIEWS OF THE DRAWINGS

FIG. 1 is a perspective view of the preferred embodiment of the present invention.

FIG. 2 is a side elevational view of the multipurpose tool of FIG. 1.

### DETAILED DESCRIPTION OF THE INVENTION

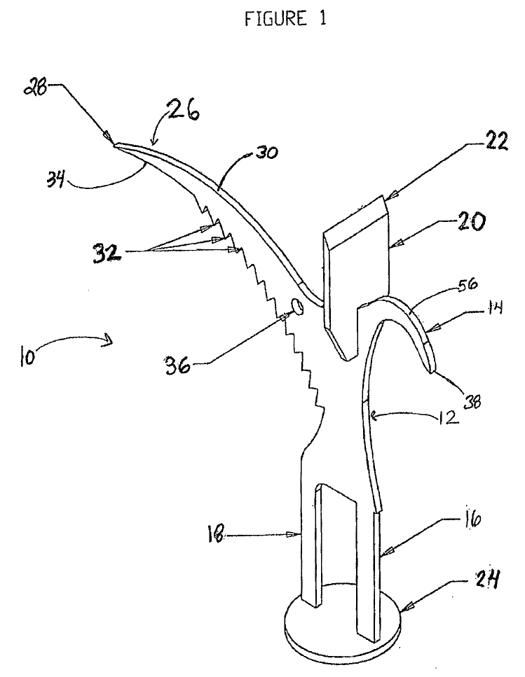

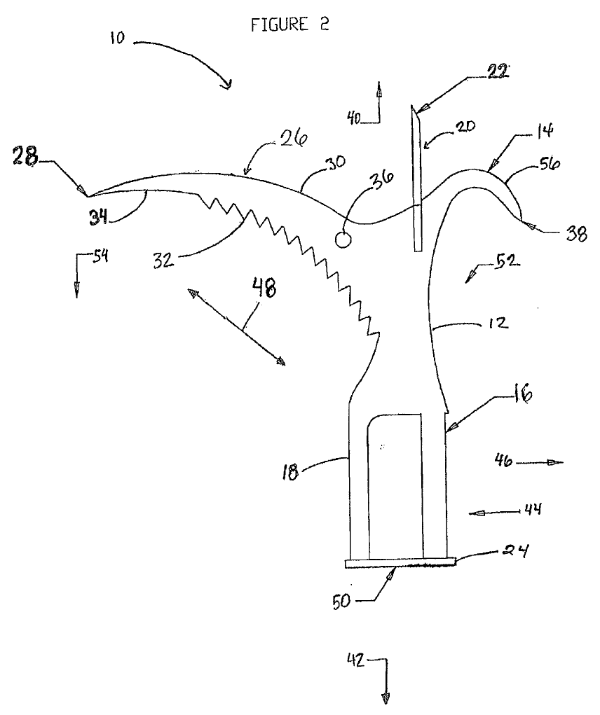

Referring to FIGS. 1-2, the preferred embodiment of the multipurpose tool 10 of the present invention is shown. Tool 10 may have a generally rigid main body 12 and one or more bases 24 extending from the main body 12. Although tool 10 is shown having a base 24 for ease of storage and for other useful functions as described below, tool 10 may or may not have a base 24. Base 24 may be constructed, sized, and shaped such that the gravitational acceleration of the mass of the tool 10, on the base 24 and a substantially flat horizontal surface with which the base 24 is engaged, balances the tool 10. Although base 24 is shown having a circular cross-sectional shape, base 24 may have any desired shape. Multipurpose tool 10 may have one or more substantially planar members 20 extending from the main body 12. Planar member 20 may be permanently attached or integral to the main body 12. Alternatively, planar member 20 may be secured to main body 12, but not permanently attached to the main body 12. Although the planar member 20 is shown having a shape of a polygon, planar member 20 may have a variety of shapes, such as but not limited to, square, rectangular, oval, triangular, irregular, or any other desired shape. Planar member 20 may or may not have a beveled edge 22.

Still referring to FIGS. 1-2, multipurpose tool 10 may have one or more serrated members 26. Serrated member 26 may be permanently attached or integral to the main body 12. Alternatively, serrated member 26 may be secured to main body 12, but not permanently attached to the main body 12. Serrated member 26 may have a top edge 30 and teeth 32. Serrated member may be tapered such that serrated member tip 28 is formed. While teeth 32 are shown in a single row in FIGS. 1-2, teeth 32 may be arranged in a number of configurations, including but not limited to two or more parallel or non-parallel rows of teeth 32. Serrated member 26 may be slightly curved as shown in FIGS. 1-2. Teeth 32 may be located opposite or underneath top edge 30. Serrated member 26 may be constructed, sized, and shaped such that at least a portion of serrated member 26 may be manually graspable. For example, in the embodiment shown in FIGS. 1-2, serrated member 26 may be manually grasped at smooth portion 34 and/or top edge 30. While smooth portion 34 is shown in FIGS. 1-2 located near the distal end of serrated member 26, smooth portion 34 may be located at any desired location along serrated member 26. Additionally, multipurpose tool 10 may have one or more curved members 14 extending from the main body 12. Curved member 14 may be permanently attached or integral to the main body 12. Alternatively, curved member 14 may be secured to main body 12, but not permanently attached to the main body 12. At least a portion of curved member 14 may be manually graspable. Further, although curved member 14 and serrated member 26 are shown at substantially the same elevation extending from main body 12, curved member 14 and serrated member 26 may be located at any desired location extending from main body 12. Curved member 14 may have a substantially tapered end 38. Alternatively, curved member 14 may not have a substantially tapered end 38.

Referring again to FIGS. 1-2, multipurpose tool 10 may have one or more handles 16, 18 extending from main body 12. Handles 16, 18 may be constructed, sized, and shaped such that handles 16, 18 may be manually graspable. Handles 16, 18 may be permanently attached or integral to the main body 12. Alternatively, handles 16, 18 may be secured to main body 12, but not permanently attached to the main body 12. Handle 18 may be constructed, sized, shaped and located in relation to handle 16 such that if handle 16 is grasped, handle 18 may at least partially protect a user's hand or arm or may be a barrier to debris or other objects that may otherwise cause injury to the user when multipurpose tool 10 is in use. Conversely, handle 16 may at least partially protect a user by similar arrangement if handle 18 is grasped. While handles 16, 18 are shown having a substantially planar shape, handles 16, 18 may have any desired shape such that handles 16, 18 may be manually graspable, including but not limited to cylindrical, polygonal, or irregular, or a combination thereof. Alternatively, main body 12 may be manually graspable and may serve as a handle.

A person of ordinary skill in the art will recognize that a multipurpose tool 10 as described herein provides the user the ability to perform a number of functions. Still referring to FIGS. 1-2, for example, and without limitation, planar member 20, and more particularly beveled edge 22, may be positioned between two or more objects or in a relatively small space such that force may be applied in direction 40 to beveled edge 22 and any item engaged with beveled edge 22. If desired, beveled edge 22 may be so positioned such that force may be applied to base 24, and more particularly a bottom surface 50 of base 24, in direction 40, including but not limited to, by applying force by way of a hammer to bottom surface 50 in direction 40. In addition, planar member 20 may be wedged between objects or in a small space, and tool 10 may be moved in alternating directions 44 and 46 in order to pry with planar member 20. In the alternative, beveled edge 22 and planar member 20 may function to chop or cut an object. Such a function may be accomplished by a user manually grasping at least a portion of serrated member 26, one or more handles 16, 18, or a combination thereof, and moving multipurpose tool 10 in direction 40.

Alternatively, by way of example and not limitation, serrated member 26, and more particularly serrated member tip 28 may be utilized to pry open a door or other object. For example, serrated member tip 28 may be placed in a door frame, and tool 10 may be moved in direction 46 by manually grasping handle 16. Such movement may result in a fulcrum being established along edge 30 which may increase the prying force at serrated member tip 28, and the prying force on any corresponding object engaged with serrated member tip 28, in direction 54. Serrated member tip 28 may also be used to pierce an object by swinging tool 10 when tool 10 is manually grasped at handle 16. Alternatively, teeth 32 may be used to saw through an object when tool 10 is moved in alternating directions as shown by 48. Additionally, curved member 14 may be used to pry by moving tool 10 in direction 44 while manually grasping tool 10 at handle 18 or handle 16. Such a movement may result in a fulcrum being established along top edge 56 of curved member 14 and may create a prying force at tapered end 38, and any corresponding object engaged with tapered end 38, in direction 52.

Referring still to FIG. 1-2, base 24, and more particularly bottom surface 50 of base 24, may be used to apply a blunt force on or to an object, when tool 10 is accelerated in direction 42. The mass of tool 10 increases the force applied to an object when utilized in this fashion.

Tool 10 may be sized and configured such that tool 10 is substantially portable. This type of configuration allows a user to easily transport tool 10 to a desired location to perform a job with the tool 10. Further enhancing the ability to transport tool 10, tool 10 may have a hole 36, through which any suitable ring or hook, such as but not limited to a lanyard, dring, or carabiner, may be threaded such that the ring or hook may be secured onto a user's belt loop, or onto any other desired location. This type of configuration allows the tool 10 to be substantially portable on a user's person without the use of any of the user's hands or arms and without substantially interfering with or hindering the user's movement.

In some embodiments, substantially all of the components of tool 10 may be made of abrasion resistant steel, such as “AR 400” for example. Substantially all of the components of tool 10 may have a tensile strength of 180-ksi (kilopounds per square inch) and Brinell hardness measurement of 360. Alternatively, the components of tool 10 may have any desired abrasion resistance, tensile strength and hardness. One skilled in the art would recognize that any of the components of tool 10 may be made of any desirable material, such as steel, metal, plastic, wood, fiberboard, fiberglass or a combination thereof. In some embodiments, tool 10 may be approximately fourteen inches when measured from bottom surface 50 to the top of planar member 20. Main body 12, base 24, planar member 20, curved member 14, and serrated member 26 may be constructed of one quarter inch thick material. Of course, tool 10 may be any desired size and the components of tool 10 may have any desired thickness and may have any desired range of proportions with respect to each other.

A person of ordinary skill in the art will recognize that a multipurpose tool 10 as described herein may be easily transported or carried by a user. As such, the multipurpose tool 10 as described herein may provide an automatic and quick solution in emergency situations at times when the user does not have access to more specialized tools or machinery. Although the foregoing specific details describe certain embodiments of this invention, persons reasonably skilled in the art will recognize that various changes may be made in the details of this invention without departing from the spirit and scope of the invention as defined in the appended claims and considering the doctrine of equivalents. Therefore, it should be understood that this invention is not to be limited to the specific details shown and described herein.

We claim:

1. A multipurpose tool comprising:
a main body;
at least one substantially planar member extending from said main body;
at least one curved member extending from said main body; and
at least one serrated member extending from said main body.

2. The multipurpose tool of claim 1 wherein said at least one curved member is manually graspable.

3. The multipurpose tool of claim 1 wherein said at least one serrated member is manually graspable.

4. The multipurpose tool of claim 1 wherein said at least one planar member comprises a beveled edge.

5. The multipurpose tool of claim 1 further comprising at least one manually graspable handle extending from said main body.

6. The multipurpose tool of claim 1 wherein said multipurpose tool has a Brinell hardness of at least 360.

7. The multipurpose tool of claim 1 wherein said multipurpose tool is made of abrasion-resistant steel.

8. The multipurpose tool of claim 1 further having a Brinell hardness measurement of at least 360.

9. The multipurpose tool of claim 1 wherein said main body is constructed from one-quarter inch thick material.

10. The multipurpose tool of claim 1 wherein said at least one substantially planar member is constructed from one-quarter inch thick material.

11. The multipurpose tool of claim 1 wherein said at least one curved member is constructed from one-quarter inch thick material.

12. The multipurpose tool of claim 1 wherein said at least one serrated member is constructed from one-quarter inch thick material.

13. The multipurpose tool of claim 1 wherein said at least one curved member comprises a substantially tapered end.

14. The multipurpose tool of claim 1 wherein said at least one serrated member comprises a smooth portion.

15. The multipurpose tool of claim 1 further comprising a securing hole disposed therethrough.

16. The multipurpose tool of claim 1 wherein said at least one serrated member comprises a serrated member tip.

17. The multipurpose tool of claim 1 further comprising a base extending from said main body and having a bottom surface wherein said base is adaptable to support the weight of said multipurpose tool.

18. The multipurpose tool of claim 5 wherein the distance between said bottom surface to the top of said at least one substantially planar member is fourteen inches.

19. The multipurpose tool of claim 5 wherein said base is constructed from one-quarter inch thick material.
